(19) United States
(12) Patent Application Publication
(10) Pub. No.: US 2016/0077937 A1
(43) Pub. Date: Mar. 17, 2016

(54) FABRIC COMPUTER COMPLEX METHOD AND SYSTEM FOR NODE FUNCTION RECOVERY

(71) Applicants: Robert F. Inforzato, Malvern, PA (US); Richard E. Blyler, Malvern, PA (US); Andrew F. Sanderson, Malvern, PA (US); Steven E. Clarke, Malvern, PA (US); Dwayne E. Ebersole, Malvern, PA (US); Steven L. Forbes, Irvine, CA (US); Andrew Ward Beale, Irvine, CA (US); Craig F. Russ, Malvern, PA (US); Craig R. Church, Malvern, PA (US); Derek W. Paul, Irvine, CA (US)

(72) Inventors: Robert F. Inforzato, Malvern, PA (US); Richard E. Blyler, Malvern, PA (US); Andrew F. Sanderson, Malvern, PA (US); Steven E. Clarke, Malvern, PA (US); Dwayne E. Ebersole, Malvern, PA (US); Steven L. Forbes, Irvine, CA (US); Andrew Ward Beale, Irvine, CA (US); Craig F. Russ, Malvern, PA (US); Craig R. Church, Malvern, PA (US); Derek W. Paul, Irvine, CA (US)

(73) Assignee: Unisys Corporation, Blue Bell, PA (US)

(21) Appl. No.: 14/487,669

(22) Filed: Sep. 16, 2014

(51) Int. Cl. G06F 11/20

(52) U.S. Cl. CPC G06F 11/2033; G06F 11/2094; G06F 2201/805

(57) ABSTRACT

A fabric computer method and system for recovering fabric computer node function. The fabric computer method includes monitoring a processing environment operating on a first Processor and Memory node within the fabric computer complex, detecting a failure of the first Processor and Memory node, and transferring the processing environment from the first Processor and Memory node to a second Processor and Memory node within the fabric computer complex in response to the detection of a failure of the first Processor and Memory node. The fabric computer system includes a first Processor and Memory node, a second Processor and Memory node coupled to the first Processor and Memory node, at least one input/output (I/O) and Networking node coupled to the first and second Processor and Memory nodes, and a fabric manager coupled to the first and second Processor and Memory nodes and the at least one I/O and Networking node. The fabric manager is configured to monitor a processing environment operating on the first Processor and Memory node, to receive notification of a failure of the first Processor and Memory node, and to transfer the processing environment from the first Processor and Memory node to the second Processor and Memory node in response to the detection of a failure of the first Processor and Memory node.

### BACKGROUND

1. Field

The instant disclosure relates to fabric computers and fabric computing, and in particular to fabric computer node failover recovery.

2. Description of the Related Art

Conventional computers systems are composed of tightly-coupled hardware modules that carry out specific functions, e.g., processor functions, memory functions, and input/output (I/O) functions. In a conventional computer system, a processor or memory failure typically means a complete failure of the entire computer system. To provide improved availability for a conventional computer system, a redundant standby computer system often is used. If a failure of the active computer system is detected, then a relatively complex failover to the standby computer system typically is required to restore system availability.

Unlike conventional computer systems, a fabric computer is a loosely coupled complex of processor, memory, storage, input/output (I/O), networking, and management functional nodes or subsystems linked by one or more high-speed communications interconnects or links. The collection of functional nodes appears as a single system from outside the fabric computer complex.

### SUMMARY

Disclosed is a fabric computer method and system for recovering fabric computer node function. The fabric computer method includes monitoring a processing environment operating on a first Processor and Memory node within the fabric computer complex, detecting a failure of the first Processor and Memory node, and transferring the processing environment from the first Processor and Memory node to a second Processor and Memory node within the fabric computer complex in response to the detection of a failure of the first Processor and Memory node. The fabric computer system includes a first Processor and Memory node having a first management agent running locally thereon, a second Processor and Memory node coupled to the first Processor and Memory node and having a second management agent running locally thereon, at least one input/output (I/O) and Networking node coupled to the first and second Processor and Memory nodes, and a fabric manager coupled to the first and second Processor and Memory nodes and coupled to the at least one I/O and Networking node. The fabric manager is configured to monitor a processing environment operating on the first Processor and Memory node. The fabric manager also is configured to receive notification of a failure of the first Processor and Memory node. The fabric manager also is configured to transfer the processing environment from the first Processor and Memory node to the second Processor and Memory node in response to the detection of a failure of the first Processor and Memory node.

### BRIEF DESCRIPTION OF THE DRAWINGS

FIG. 1 is a schematic view of a fabric computer complex during normal operation, according to an embodiment;

FIG. 2 is a schematic view of a fabric computer complex during a failure of the active Processing Environment, according to an embodiment; and

FIG. 3 is a flow diagram of a method for fabric node recovery within a fabric computer complex, according to an embodiment.

### DETAILED DESCRIPTION

In the following description, like reference numerals indicate like components to enhance the understanding of the disclosed methods and systems through the description of the drawings. Also, although specific features, configurations and arrangements are discussed hereinbelow, it should be understood that such is done for illustrative purposes only. A person skilled in the relevant art will recognize that other steps, configurations and arrangements are useful without departing from the spirit and scope of the disclosure.

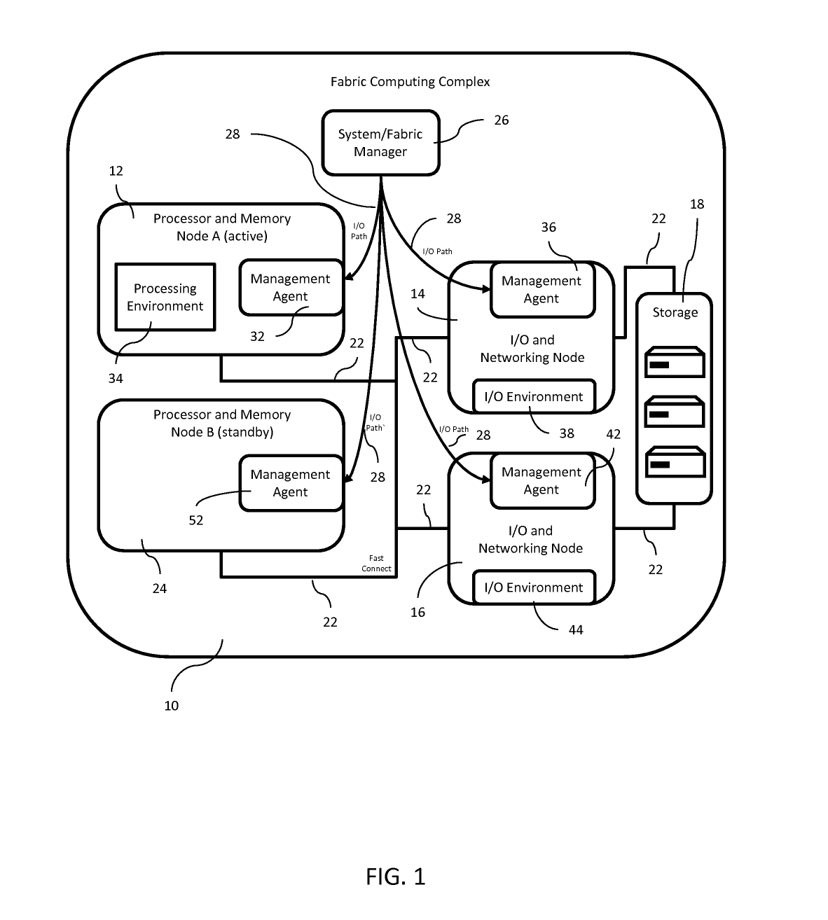

FIG. 1 is a schematic view of a fabric computer complex 10 during normal operation, according to an embodiment. The fabric computing complex 10 includes a primary or active Processor and Memory node 12, an input/output (I/O) and Networking subsystem comprised of one or more I/O and Networking nodes 14, 18. The fabric computing complex 10 also includes one or more peripheral nodes, such as a data storage node 18. The nodes are coupled or linked together by a system of high-speed communications interconnects or links 22, such as 10 gigabit Ethernet or InfiniBand.

According to an embodiment the fabric computer complex 10 also includes one or more redundant, standby Processor and Memory nodes 24 connected to the other nodes in the fabric computer complex 10 via the system of high-speed communications interconnects 22. The fabric computer complex 10 also includes a system or fabric manager 28, which is logically connected to the other nodes in the fabric computer complex 10. The logical connections between the fabric manager 26 and the other nodes in the fabric computer complex 10 (shown as logical connections 28) typically occur via the system of high-speed communications Interconnects 22.

The Processor and Memory node 12 contains the central processing unit (CPU) and the main system memory for the fabric computer complex 10. The Processor and Memory node 12 also includes a management agent 32, which runs locally on the Processor and Memory node 12 and carries out local operations for the fabric manager 26. The management agent 32 is logically coupled to the fabric manager 26 via a logical connection 28.

During normal operation, the Processor and Memory node 12 is the primary or active processor and memory node, and therefore also includes a processing environment 34 that runs or operates on the Processor and Memory node 12. The processing environment 34 is the environment where applications for the fabric computer complex 10 run.

The I/O and Networking node 14 performs input/output processes of the fabric computer 10. The I/O and Networking node 14 includes a management agent 36, which is logically coupled to the fabric manager 26 (via logical connection 28). The management agent 36 runs locally on the I/O and Networking node 14 and performs local operations for the fabric manager 26. The I/O and Networking node 14 also includes an I/O engine or environment 38, which is responsible for data transfer operations between system memory (residing on the Processor and Memory node 12) and storage devices, e.g., disk drives and other peripheral nodes 18. The I/O environment 38 also carries out data transfer operations for the processing environment 34 within the Processor and Memory node 12.

The I/O and Networking node 18 also performs input/output processes of the fabric computer 10. The I/O and Networking node 18 includes a management agent 42, which is logically coupled to the fabric manager 26 (via logical connection 28). The management agent 42 runs locally on the I/O and Networking node 14 and performs local operations for the fabric manager 28. The I/O and Networking node 16 also includes an I/O engine or environment 44, which is responsible for data transfer operations between system memory (residing on the Processor and Memory node 12) and storage devices, e.g., disk drives and other peripheral nodes 18. The I/O environment 44 also carries out data transfer operations for the processing environment 34 within the Processor and Memory node 12.

One or both of the I/O and Networking nodes 14, 16 can include a networking node (not shown). The networking node interfaces with remote entities and performs various networking operations with the remote entities.

The processing environment 34 within the primary or active Processor and Memory node 12 is logically connected to the I/O environment 38 of the I/O and Networking node 14 and to the I/O environment 44 of the I/O and Networking node 16. The logical connections between the processing environment 34 within the primary or active Processor and Memory node 12 and the I/O environments of the I/O and Networking nodes 14, 16 are shown as logical I/O paths 48, 48, respectively. The I/O paths 48, 48 are logical communication links over the fast interconnection links 22 between the processing environment 34 within the active Processor and Memory node 12 and the I/O environments 38, 44 of the I/O and Networking nodes 14, 16.

According to an embodiment, the fabric manager 26 is a module responsible for managing various nodes and components of the fabric computer complex 10. The operation and functions of the fabric manager 26 are described in greater detail hereinbelow.

The data storage node 18 provides data storage for the fabric computer complex 10. The data storage node 18 is connected to the I/O and Networking nodes 14, 16, or other appropriate nodes within the fabric computer complex 10, via the system of high-speed communications Interconnects 22. In addition to the data storage node 18, the fabric computer complex 10 also can include other peripheral nodes (not shown) connected to one or more nodes within the fabric computer complex 10.

According to an embodiment, the redundant, standby Processor and Memory node 24 is connected to the other nodes in the fabric computer complex 10 via the system of high-speed communications Interconnects 22. The redundant, standby Processor and Memory node 24 includes a management agent 52, which is logically coupled to the fabric manager 26 via a logical connection 28. The management agent 52 runs locally on the redundant, standby Processor and Memory node 24 and carries out local operations for the fabric manager 26.

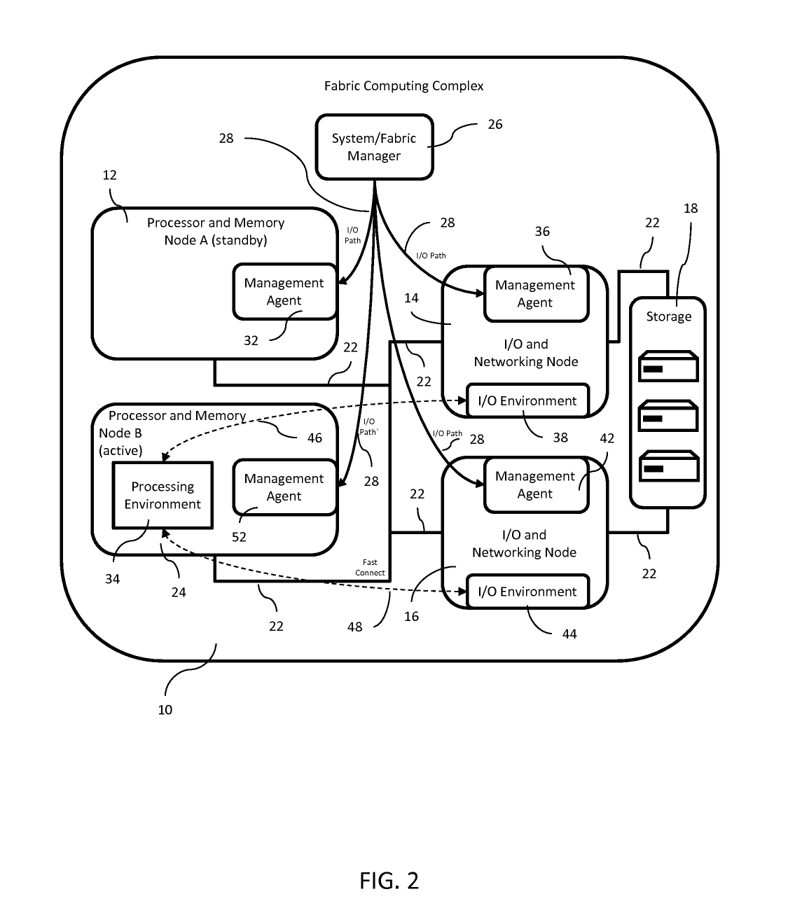

FIG. 2 is a schematic view of a fabric computer complex 10 during a failure of the active Processing Environment, according to an embodiment. According to an embodiment, to improve system availability, the fabric computer complex 10 includes one or more redundant, standby nodes to rapidly take over functions from a failed node within the fabric computer complex 10. For example, In the fabric computer complex 10, the redundant, standby Processor and Memory node 24 is connected to the I/O and Networking subsystem, which is comprised of I/O and Networking nodes 14, 16. In the event that the active Processor and Memory node 12 falls, the processor and memory functions of the failed Processor and Memory node 12 are moved quickly to the redundant, standby Processor and Memory node 24, using the same I/O and Networking subsystem, and overall system availability is restored quickly.

During initial and normal operation, the processing environment 34 operates on the primary and active Processor and Memory node 12. The redundant, standby Processor and Memory node 24 is on standby status. The fabric manager 26 monitors the active processing environment 34 operating on the active Processor and Memory node 12.

If the fabric manager 26 detects a failure of the processing environment 34 operating on the active Processor and Memory node 12, then a failover of the processing environment 34 to the standby Processor and Memory node 24 is performed automatically by the fabric manager 26. After the failover is complete, the processing environment 34 resumes operation on the standby Processor and Memory node.

To perform an automatic failover of the processing environment 34 from a failed active Processor and Memory node (e.g., the active Processor and Memory node 12) to a standby Processor and Memory node (e.g., the standby Processor and Memory node 24) the fabric manager 28 performs a number of steps. Initially, the fabric manager 26 flushes the I/O environments, i.e., the I/O environment 38 of the I/O and Networking node 14 and the I/O environment 44 of the I/O and Networking node 16. Next, the fabric manager 26 makes the processor and memory platform of the standby Processor and Memory node 24 the active processor and memory platform.

Once the processor and memory platform of the standby Processor and Memory node 24 has been made the active processor and memory platform, the fabric manager 26 reconfigures the I/O environments 38, 44 to recognize the newly active processor and memory platform. Then, the fabric manager 26 activates the processing environment 34 on the now-active Processor and Memory node 24. As shown In FIG. 2, the processing environment 34, which previously was operating on the previously-active Processor and Memory node 12, now is operating on the now-active Processor and Memory node 24.

According to an embodiment, the fabric manager 26 maintains communication with the management agent running locally on the Processor and Memory node (i.e., the management agent 32 running locally on the Processor and Memory node 12) via a logical connection 28. If the fabric manager 26 loses communication with the management agent, then the node is considered failed and failover to the standby Processor and Memory node commences.

The management agent running locally on the active Processor and Memory node heartbeats the local processing environment 34. If a heartbeat failure occurs, then the management agent notifies the fabric manager 26. The fabric manager 28 then initiates a failover to the standby Processor and Memory node.

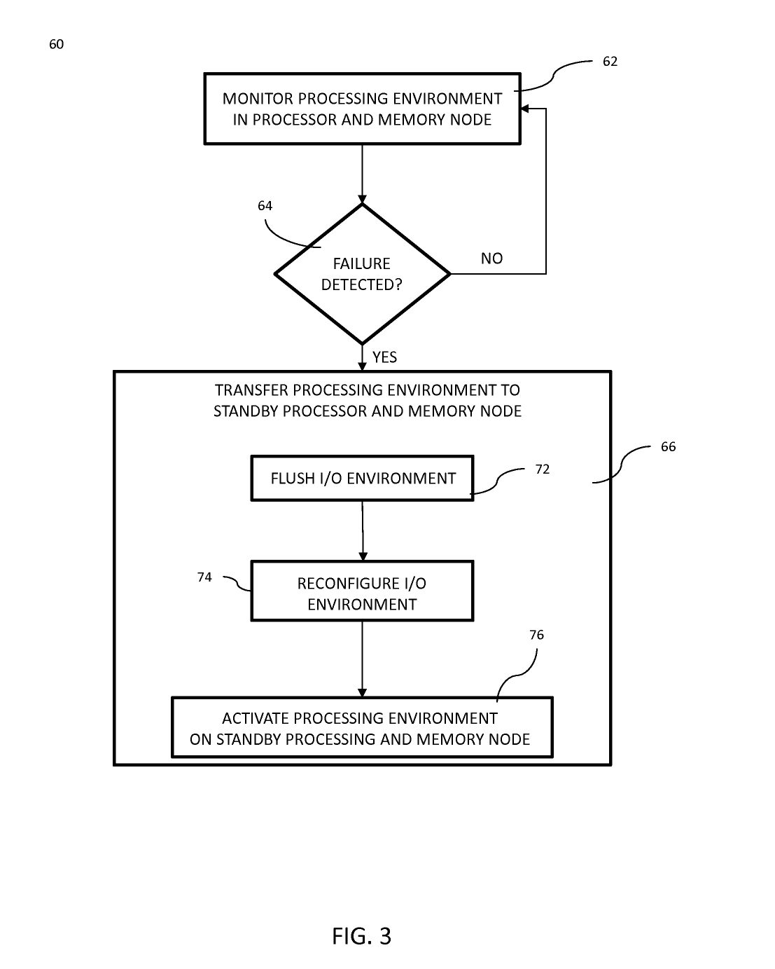

FIG. 3 is a flow diagram of a method 60 for fabric node recovery within a fabric computer complex, according to an embodiment. The method 60 includes a step 62 of monitoring the processing environment 34 running locally on the active Processor and Memory node 12. As discussed hereinabove, the management agent 32 running locally on the active Processor and Memory node 12 heartbeats the processing environment 34, and the fabric manager 28 maintains communication with the management agent 32.

The method 60 also includes a step 64 of detecting a failure of the active Processor and Memory node 12. If there is no heartbeat failure by the local processing environment 34 running on the active Processor and Memory node 12, then the management agent 32 will not detect a failure (NO). In this case, the method 60 returns to the step 62 of monitoring the processing environment 34 running locally on the active Processor and Memory node 12. If the processing environment 34 running on the active Processor and Memory node 12 suffers a heartbeat failure, the management agent 32 detects the failure (YES) and notifies the fabric manager 26 of such failure.

The method 80 also includes a step 66 of transferring the processing environment 34 from the active Processor and Memory node 12 to the standby Processor and Memory node 24. When the management agent 32 notifies the fabric manager 28 of a failure of the processing environment 34 within the Processor and Memory node 12, the Processor and Memory node 12 is considered failed, and the fabric manager 26 begins transferring the processing environment 34 from the failed Processor and Memory node 12 to the standby Processor and Memory node 24.

The transfer step 66 includes a step 72 of flushing the I/O environment(s). As discussed hereinabove, once the node failover process begins, the fabric manager 26 initially flushes the I/O environments, i.e., the I/O environment 38 of the I/O and Networking node 14 and the I/O environment 44 of the I/O and Networking node 16.

The transfer step 66 also includes a step 74 of reconfiguring the I/O environments. As discussed hereinabove, once the I/O environments have been flushed, and the fabric manager 26 makes the processor and memory platform of the standby Processor and Memory node 24 the active processor and memory platform, the fabric manager 26 reconfigures the I/O environments 38, 44 to recognize the newly active processor and memory platform.

The transfer step 66 also includes a step 78 of activating the processing environment 34 on the standby (and now active) Processor and Memory node 24. As discussed hereinabove, once the I/O environments 38, 44 have been reconfigured to recognize the newly active processor and memory platform, the fabric manager 26 activates the processing environment 34 on the now-active Processor and Memory node 24. The processing environment 34 then begins operating on the now-active Processor and Memory node 24.

The functions described herein may be implemented in hardware, firmware, or any combination thereof. The methods illustrated in the FIGS. may be implemented in a general, multi-purpose or single purpose processor. Such a processor will execute instructions, either at the assembly, compiled or machine-level, to perform that process. Those instructions can be written by one of ordinary skill in the art following the description of the figures and stored or transmitted on a non-transitory computer readable medium. The instructions may also be created using source code or any other known computer-aided design tool. A non-transitory computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), and the like.

It will be apparent to those skilled in the art that many changes and substitutions can be made to the embodiments described herein without departing from the spirit and scope of the disclosure as defined by the appended claims and their full scope of equivalents.

1. A method for operating a fabric computer complex, comprising: monitoring a processing environment operating on a first Processor and Memory
node within the fabric computer complex;
detecting a failure of the first Processor and Memory node; and
transferring the processing environment from the first Processor and Memory node to a second Processor and Memory node within the fabric computer complex in response to the detection of a failure of the first Processor and Memory node.

2. The method as recited in claim 1, wherein transferring the processing environment from the first Processor and Memory node to the second Processor and Memory node includes:
flushing an input/output (I/O) environment within at least one input/output (I/O) and Networking node coupled to the first and second Processor and Memory nodes,
reconfiguring the I/O environment within the at least one I/O and Networking node to recognize the second Processor and Memory node, and
activating the processing environment on the second Processor and Memory node.

3. The method as recited in claim 1, wherein monitoring the first Processor and Memory node includes maintaining communication with a management agent running locally on the first Processor and Memory node.

4. The method as recited in claim 1, wherein detecting a failure of the first Processor and Memory node includes losing communication with a management agent running locally on the first Processor and Memory node.

5. The method as recited in claim 1, wherein the first Processor and Memory node includes a management agent that heartbeats the processing environment operating on the first Processor and Memory node, and wherein detecting a failure of the first Processor and Memory node includes the management agent providing notification of a failure of the first Processor and Memory node if a heartbeat failure occurs between the management agent and the processing environment operating on the first Processor and Memory node.

6. The method as recited in claim 1, wherein monitoring the processing environment operating on the first Processor and Memory node is performed by a fabric manager coupled to the first and second Processor and Memory nodes.

7. The method as recited in claim 1, wherein transferring the processing environment from the first Processor and Memory node to the second Processor and Memory node is performed by a fabric manager coupled to the first and second Processor and Memory nodes.

8. The method as recited in claim 7, wherein detecting a failure of the first Processor and Memory node includes a management agent running locally on the first Processor and Memory node providing to the fabric manager notification of a failure of the first Processor and Memory node if a heartbeat failure occurs between the management agent and the processing environment operating on the first Processor and Memory node.

9. A fabric computer complex, comprising:
a first Processor and Memory node having a first management agent running locally thereon;
a second Processor and Memory node coupled to the first Processor and Memory node and having a second management agent running locally thereon;
at least one input/output (I/O) and Networking node coupled to the first and second Processor and Memory nodes; and
a fabric manager coupled to the first and second Processor and Memory nodes and coupled to the at least one I/O and Networking node,
wherein the fabric manager is configured to monitor a processing environment operating on the first Processor and Memory node,
wherein the fabric manager is configured to receive notification of a failure of the first Processor and Memory node, and
wherein the fabric manager is configured to transfer the processing environment from the first Processor and Memory node to the second Processor and Memory node in response to the detection of a failure of the first Processor and Memory node.

10. The fabric computer complex as recited in claim 9, wherein the fabric manager transferring the processing environment from the first Processor and Memory node to the second Processor and Memory node includes:
flushing an input/output (I/O) environment within the at least one I/O and Networking node,
reconfiguring the I/O environment within the I/O and Networking node to recognize the second Processor and Memory node, and
activating the processing environment on the second Processor and Memory node.

11. The fabric computer complex as recited in claim 9, wherein the fabric manager monitoring the first Processor and Memory node includes maintaining communication with the management agent on the first Processor and Memory node.

12. The fabric computer complex as recited in claim 9, wherein the fabric manager is configured to detect a failure of the first Processor and Memory node in response to losing communication with the management agent on the first Processor and Memory node.

13. The fabric computer complex as recited in claim 9, wherein the management agent running locally on the first Processor and Memory node heartbeats the processing environment operating on the first Processor and Memory node management, and wherein the management agent running locally on the first Processor and Memory node notifies the fabric manager of a failure of the first Processor and Memory node if a heartbeat failure occurs between the management agent running locally on the first Processor and Memory node and the processing environment operating on the first Processor and Memory node.

14. A fabric management apparatus for use within a fabric computer complex having a first active Processor and Memory node, a second standby Processor and Memory node coupled to the active Processor and Memory node, and at least one input/output (I/O) and Networking node coupled to the first active Processor and Memory node and the second standby Processor and Memory node, wherein the fabric management apparatus is configured to perform the steps of:
monitoring a processing environment operating on the first active Processor and Memory node;
receiving notification of a failure of the first active Processor and Memory node;
transferring the processing environment from the first active Processor and Memory node to the second standby Processor and Memory node in response to the detection of a failure of the first active Processor and Memory node.

15. The fabric management apparatus as recited in claim 14, wherein the fabric management apparatus transferring the processing environment from the first active Processor and Memory node to the second standby Processor and Memory node in response to the detection of a failure of the first active Processor and Memory node includes:
flushing an input/output (I/O) environment within the at least one I/O and Networking node,
reconfiguring the I/O environment within the I/O and Networking node to recognize the second standby Processor and Memory node, and
activating the processing environment on the second standby Processor and Memory node.

16. The fabric management apparatus as recited in claim 14, wherein the fabric manager apparatus monitoring the first active Processor and Memory node includes maintaining communication with a management agent running locally on the first active Processor and Memory node.

17. The fabric management apparatus as recited in claim 18, wherein the fabric management apparatus is configured to detect a failure of the first active Processor and Memory node in response to losing communication with the management agent running locally on the first active Processor and Memory node.

18. The fabric management apparatus as recited in claim 14, wherein the management agent running locally on the first active Processor and Memory node heartbeats the processing environment operating on the first active Processor and Memory node management, and wherein the management agent running locally on the first active Processor and Memory node notifies the fabric management apparatus of a failure of the first active Processor and Memory node if a heartbeat failure occurs between the management agent running locally on the first active Processor and Memory node and the processing environment operating on the first active Processor and Memory node.
